(19) United States
(12) Patent Application Publication
(10) Pub. No.: US 2018/0128109 A1
(43) Pub. Date: May 10, 2018

(54) RADIAL TURBINE WITH BONDED SINGLE CRYSTAL BLADES

(71) Applicant: Rolls-Royce North American Technologies Inc., Indianapolis, IN (US)

(72) Inventors: Ryan C. Humes, Indianapolis, IN (US); Brad J. Riehle, Plainfield, IN (US); Douglas D. Dierksmeier, Franklin, IN (US)

(21) Appl. No.: 15/346,450

(22) Filed: Nov. 8, 2016

(51) Int. Cl. F01D 5/04; F01D 5/18

(52) U.S. Cl. CPC F01D 5/048; F01D 5/18; F05D 2240/30; F05D 2220/32; F05D 2230/236; F05D 2260/20; F05D 2230/237; F05D 2230/239; F05D 2300/607

(57) ABSTRACT

A radial turbine rotor for a gas turbine engine may be provided. The radial turbine rotor may include a hub and a plurality of radial turbine blades. The hub may include an outer surface. The outer surface of the hub may include a plurality of discrete bonding surfaces. The radial turbine blades may be bonded to a corresponding one of the discrete bonding surfaces of the hub. Each of the radial turbine blades may be separate and distinct from the other radial turbine blades that are bonded to the radial turbine rotor. The corresponding discrete bonding surface may include a planer surface to receive the radial turbine blade.

### TECHNICAL FIELD

This disclosure relates to radial turbine engines and, in particular, to radial turbine rotors.

### BACKGROUND

In many applications, a radial turbine engine may be desirable over other types of turbine engines, such as axial turbine engines. Present approaches to radial turbine technology are limited by drawbacks, limitations, and disadvantages of traditional radial turbine rotors. A radial turbine rotor and its various components may be subject to high temperatures and substantial stress while operating in a turbine engine. Thus, there is a need for the inventive radial turbine rotor components, apparatuses, systems and methods disclosed herein.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 illustrates aside plan view of an example of a radial turbine rotor for a gas turbine engine;

FIG. 2 illustrates a front plan view of an example of a radial turbine rotor;

FIG. 3 illustrates a rear plan view of an example of a radial turbine rotor;

FIG. 4 illustrates a rear plan view of example of a radial turbine rotor including an inner hub and an outer ring;

FIG. 5 illustrates a front plan view of an example of a radial turbine rotor including an inner hub and an outer ring;

FIG. 6 illustrates a side plan view of an example of a radial turbine rotor including an inner hub and an outer ring;

FIG. 7 illustrates a perspective view of an example of a radial turbine blade with adjacent radial turbine blades;

FIG. 8 illustrates a rear plan view of an example of a radial turbine blade with adjacent radial turbine blades on a radial turbine rotor;

FIG. 9 illustrates a perspective view of an example of a radial turbine rotor with individually bonded blades;

FIG. 10 illustrates a side view of an example of a radial turbine rotor with individually bonded blades; and

FIG. 11 illustrates an example of a portion of a gas turbine engine with a radial turbine blade.

### DETAILED DESCRIPTION

In many circumstances, radial turbine engines may be desirable over other types of turbine engines. The features included in traditional radial turbine rotors may be limited by the design and manufacturing processes of traditional radial turbine rotors. In many traditional radial turbine rotors, the blades of the radial turbine rotors are formed with the entire rotor assembly. Accordingly, the features of blades, or other components of the traditional radial turbine rotors, may be limited. Methods, systems, and apparatus for a radial turbine rotor are provided.

By way of an introductory example, a radial turbine rotor for a gas turbine engine may include a hub and a plurality of radial turbine blades. The hub may include an outer surface. The outer surface of the hub may include a plurality of discrete bonding surfaces. The radial turbine blades may be bonded to a corresponding one of the discrete bonding surfaces of the hub. Each of the radial turbine blades may be separate and distinct from the other radial turbine blades that are bonded to the radial turbine rotor. The corresponding discrete bonding surface may include a planer surface to receive the radial turbine bade.

One interesting feature of the systems and methods described below may be that the radial turbine blade may have additional features, such as cooling features, that may be difficult or impossible to have with traditional radial turbine rotors. Alternatively, or in addition, an interesting feature of the systems and methods described below may include increased structural integrity of the radial turbine rotor.

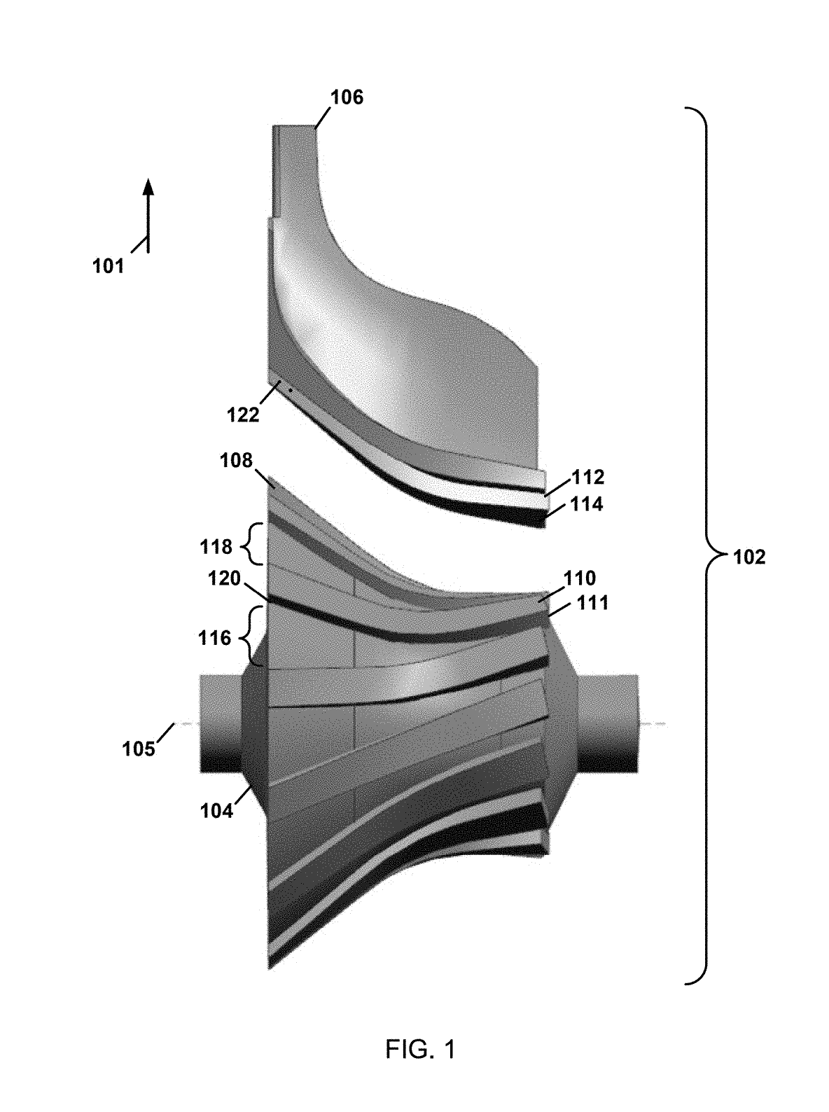

FIG. 1 illustrates a side plan view of an example of a radial turbine rotor 102 for a gas turbine engine. The radial turbine rotor 102 includes a hub 104, a radial turbine blade 106, and additional radial turbine blades (not shown in FIG. 1). The radial turbine rotor 102 may be a mechanical component of a turbine engine that extracts energy from a fluid flow. The radial turbine rotor 102 may rotate about a rotational axis 105 and drive a shaft (not shown) in the radial turbine engine. The fluid flow in the radial turbine engine may be radial 101, or semi-radial, to the rotational axis 105 of the radial turbine rotor 102. The fluid flow may apply force to the radial turbine blade 106, which results in the rotation of the radial turbine rotor 102. The radial turbine rotor 102 may be located in any portion of the radial turbine engine. For example, the radial turbine rotor 102 may be located in the exhaust portion of the radial turbine engine. Thus, the radial turbine rotor 102 may experience substantial mechanical stress due to the pressures, extreme thermodynamics, and other factors present in a hot section, or other sections, of the radial turbine engine.

It may be desirable to form the individual components of the radial turbine rotor 102 separately. Accordingly, the radial turbine rotor 102 may be a combination of individual components joined together. For example, the radial turbine rotor 102 may include a hub 104 and discrete radial turbine blades, such as the radial turbine blade 106 illustrated in FIG. 1. The hub 104, the radial turbine blade 106, and/or other components of the radial turbine rotor 102 may include, for example, features suitable to improve the performance, efficiency, sustainability, feasibility, and other design considerations of the radial turbine engine. A manufacturing process may produce the individual components of the radial turbine rotor 102, such as the radial turbine blades, before joining the components. In some examples, the individual components of the radial turbine rotor 102, such as the radial turbine blade 106 and the hub 104, are joined together by a bonding process. The bonding process may include brazing, linear precision welding, diffusion bonding, inertia welding or any other bonding process suitable to join the hub 104, the radial turbine blade 106, and/or other components of radial turbine rotor 102, such as the other radial turbine blades.

The hub 104 may be a component of the radial turbine rotor 102 that rotates about the rotational axis 105 on the radial turbine engine. In some examples, the hub 104 may be connected with a shaft that drives the radial turbine engine. Other components of the radial turbine rotor 102, such as the radial turbine blades (for example the radial turbine blade 106 illustrated in FIG. 1), may join the hub 104 and rotate with the hub 104. The shape of the hub 104 may include a cylinder, a cone, or any other shape. For example, a hub 104 may taper along a curve convergent to the rotational axis 105 of the hub 104. The materials of the hub 104 and the radial turbine blades may include any suitable material, such as hardened steel. Alternatively, or in addition, the hub 104 may include materials that differ from materials of the radial turbine blade 106.

Each of the radial turbine blades, such as the radial turbine blade 106 illustrated in FIG. 1, may be a structure responsive to fluid flow on the radial turbine rotor 102. The radial turbine blade 106 may include a curved portion to receive fluid flow in a radial turbine engine. For example, the radial turbine blade 106 may include an airfoil, a spar, a coversheet, or any other component of a blade. In some examples, each of the radial turbine blades may include a dual wall airfoil. In addition, each of the radial turbine blades may include various materials and combinations of materials. For example, each of the radial turbine blades may include a single crystal material, an equifax material, and/or any other suitable material. The radial turbine blades or a subset thereof, may be to the same or similar to the radial turbine blade 106 illustrated in FIG. 1 and described herein. The radial turbine blade 106 may be separate and distinct from the other radial turbine blades of the radial turbine rotor 102. For example, the radial turbine blade 106 may not contact, intersect, or form any part of the other radial turbine blades.

The hub 104 may include an outer surface 108. The outer surface 108 of the hub 104 may be an outside surface of the hub 104 positioned radially outward from the rotational axis 105 of the hub 104. The outer surface 108 of the hub 104 may include a discrete bonding surface 110. The discrete bonding surface 110 may be a portion of the outer surface 108 of the hub 104 designated to receive the radial turbine blade 106. The hub 104 may include a plurality of discrete bonding surfaces similar to the discrete bonding surface 110 illustrated in FIG. 1 or otherwise described herein. The discrete bonding surface 110 may be separate and distinct from other discrete bonding surfaces of the hub 104. For example, the discrete bonding surface 110 may not join, intersect, or otherwise form any portion of any of the other discrete bonding surfaces on the outer surface 108 of the hub 104.

Alternatively, or in addition, the hub may include a lug 111. The lug 111 may be a raised portion of the hub 104 that bonds to the radial turbine blade 106. The outer surface 108 of the hub 104 may include an outer surface of the lug 111. Alternatively, or in addition, the outer surface of the lug 111 may include all, or a portion of, the discrete bonding surface 110. The hub 104 may include multiple lugs, each of the lugs separate and distinct from each other.

The radial turbine blade 106 may include a base end 112. The base end 112 of the radial turbine blade 106 may be a portion of the radial turbine blade 106 that joins the radial turbine rotor 102. For example, the base end 112 of the radial turbine blade 106 may include a stalk that protrudes out of the radial turbine blade 106. The stalk may be the portion of the radial turbine blade 106 that bonds with the hub 104. The stalk of the radial turbine blade 106 may be separate and distinct from the stalks of other radial turbine blades on the radial turbine rotor 102. The radial turbine blade 106 may extend from the base end 112 of the radial turbine blade 106 independent of the other blades of the radial turbine rotor 102. Additionally or alternately, the base end 112 of the radial turbine blade 106 may be separate and distinct from other radial turbine blades on the radial turbine rotor 102. In some examples, the base end 112 of the radial turbine blade 106 may include a base surface 114. The base surface 114 may join the discrete bonding surface 110 of the hub 104 by the bonding process. The base surface 114 of the radial turbine blade 106 may conform to the contours of the discrete bonding surface 110. For example, the discrete bonding surface 110, or a portion thereof, may be planer. In addition, the base surface 114 of the radial turbine blade 106, or a portion thereof, may be planer. In other examples, the base surface 114 of the radial turbine blade 106 and/or the discrete bonding surface 110 may follow other contours.

The radial turbine blade 106 may independently join to the radial turbine rotor 102. The discrete bonding surface 110 may isolate the radial turbine blade 106 from the other radial turbine blades of the radial turbine rotor 102. In addition, the radial turbine blade 106 may extend away from the discrete bonding surface 110 independent of the other radial turbine blades of the radial turbine rotor 102. The radial turbine blade 106 may be a unitary blade that not contact, intersect, or otherwise form any portion of the other radial turbine blades of the radial turbine rotor 102.

The hub 104 of the radial turbine rotor 102 may further include a first saddle 116 and a second saddle 118 along the outer surface 108 of the hub 104. The saddles 116, 118 may be a portion of the hub 104 positioned on either side of the radial turbine blade 106. The saddles 116, 118 may separate the radial turbine blade 106 from at least one of the other radial turbine blades of the radial turbine rotor 102. The discrete bonding surface 110 may be positioned between the first saddle 116 and the second saddle 118. Thus, the saddles 116, 118 may isolate the discrete bonding surface 110 from other discrete bonding surfaces of the hub 104. In addition, the saddle may isolate the radial turbine blade 106 from the other radial turbine blades of the radial turbine rotor 102.

The hub 104 may include a fillet. The fillet may a tapered region of the hub 104 along a portion of the hub 104 where the radial turbine blade 106 bonds to the hub 104. For example, the fillet may be a region of the hub 104 along an outer perimeter of the lug 111. In some examples, the fillet may be located at a juncture 120 of the lug 111 and a portion of the outer surface of the hub 104 between the lug 111 and adjacent lugs. Additionally or alternatively, the fillet may be positioned at the outer surface 108 of the hub 104 along the base end 112 of the radial turbine blade 106 bonded to the hub 104. In some examples, the fillet may be an arcuate, curved, or otherwise tapered. The saddles 116, 118 may include all or a portion of the fillet. Further, the fillet may a portion of the hub 104 that recesses the at least one of the saddles 116, 118 radially inward on the hub 104.

One of the many advantages of individually bonding the radial turbine blade 106 with the hub 104 may be that various cooling features and configurations may be achieved. Cooling features may be included on the radial turbine blade 106, the hub, and/or other components of the radial turbine engine. The cooling features may be configured to direct the flow of cooling fluid received from a cooling fluid source. Advanced cooling features and configurations on the radial turbine rotor 102 may improve the structural integrity, and other design considerations, of the radial turbine rotor 102 and/or other components of the radial turbine engine.

The radial turbine blade 106 may include cooling features. For example, the radial turbine blade 106 may include a cooling hole 122. The cooling hole 122, or multiple cooling holes, may be positioned at any location on the radial turbine blade 106. For example, the base end 112 of the radial turbine blade 106 may include the cooling hole 122. The cooling hole 122 may be located on the back of the base end 112 and/or along the side of the base end 112, as illustrated in FIG. 1. The cooling hole 122 may direct cooling fluid in or out of the radial turbine blade. For example, the cooling hole 122 may direct cooling direct fluid onto the lug 111, the saddles 116, 118, the junction 120, the fillet, or other portions of the radial turbine rotor that neighbor the cooling hole 122.

The radial turbine blade 106 may include an internal passageway (not shown in FIG. 1). The internal passage may be a cavity inside of the radial turbine blade 106. The internal passageway may direct cooling fluid inside of the radial turbine blade 106. The internal passageway may connect with other cooling features on the radial turbine blade 106. For example, the internal passageway may connect with the cooling hole 122 to direct cooling fluid in or out of the hub.

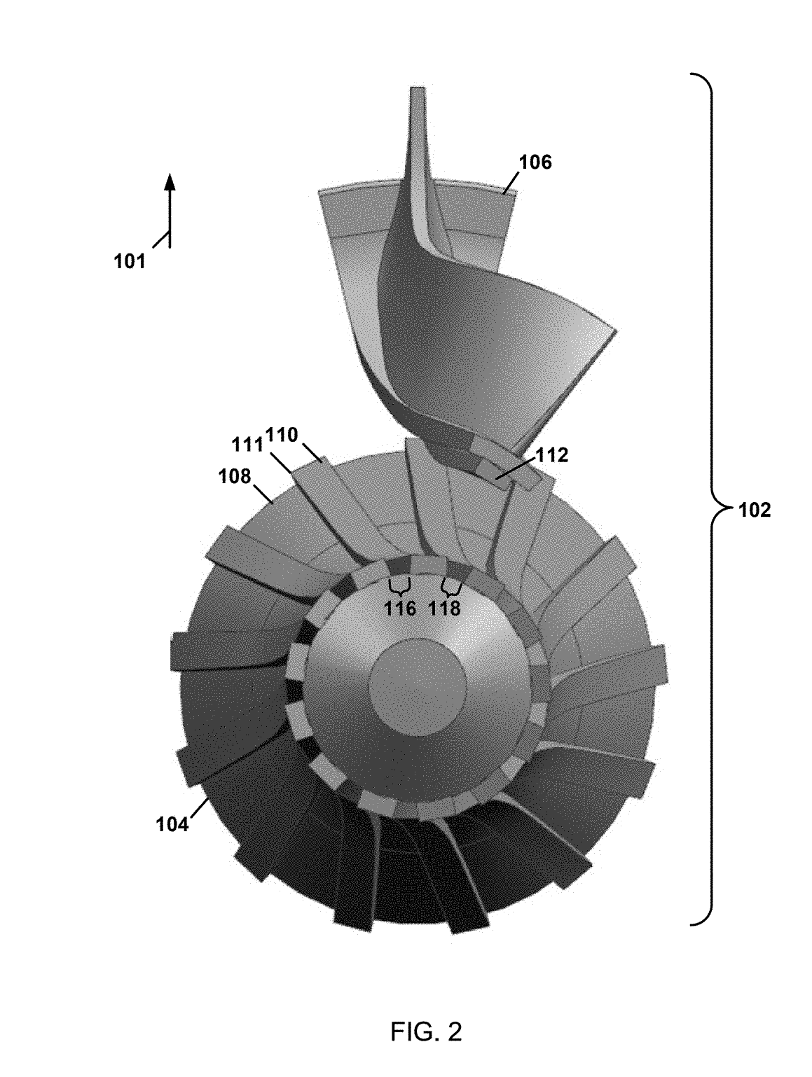

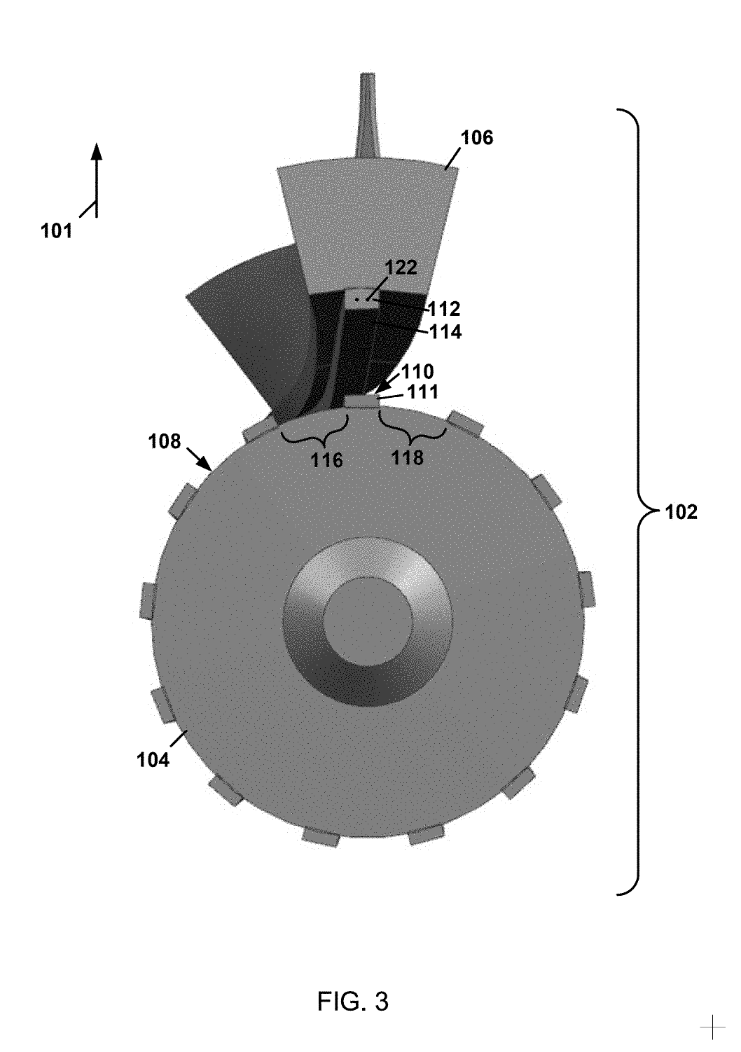

FIG. 2 illustrates a front plan view of the radial turbine rotor 102, and FIG. 3 illustrates a rear plan view of the radial turbine rotor 102. In FIGS. 1-3, the radial turbine blade 106 is positioned above the lug 111. The manufacturing of the radial turbine rotor 102 may follow a process which may include positioning the radial turbine blade 106 along the outer surface 108 of the hub 104. The process may further include aligning the base end 112 of the radial turbine blade 106 with the lug 111 of the hub. The process may further include bonding the base surface 114 with the discrete bonding surface 110.

In some examples, the radial turbine rotor 102 may include components alternatively, or in addition, to the hub 104 and the radial turbine blade 106. These components may be bonded in various manners to maximize feasibility, structural integrity, and other design consideration of the radial turbine engine.

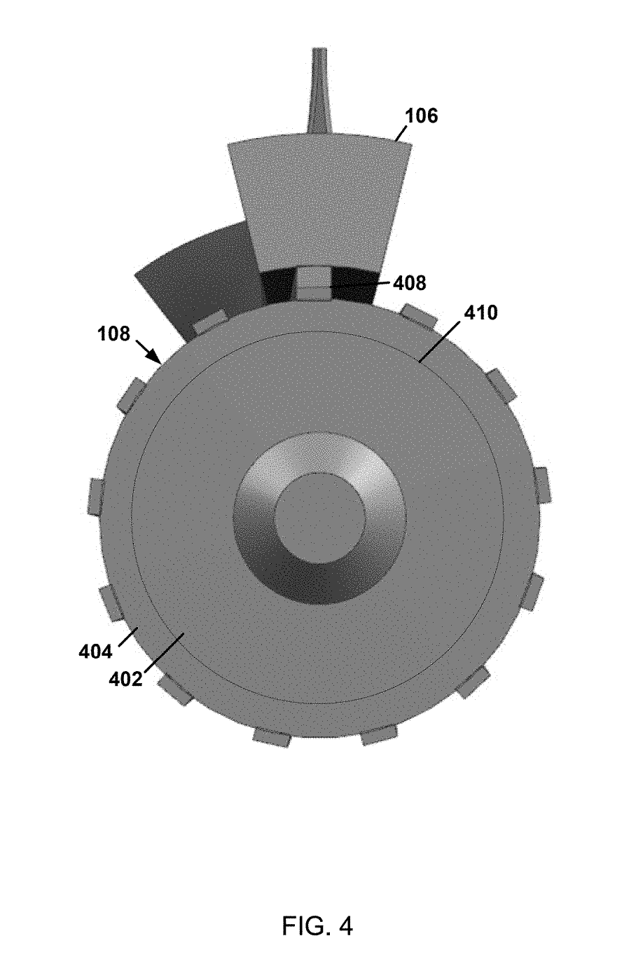

FIG. 4 illustrates a rear plan view of an example of the radial turbine rotor 102 including an inner hub 402 and an outer ring 404. In some examples, the hub 104 may include the inner hub 402 and the outer ring 404. Alternatively, the inner hub 402 and the outer ring 404 may be a separate component from the hub 104. The inner hub 402 may be a structure that rotates the radial turbine rotor 102. In some examples, the inner hub 402 may be connected with a shaft that drives the radial turbine engine. The shape of the inner hub 402 may be a cylinder, cone, or any other shape. For example, the inner hub 402 may taper along a curve convergent to the rotational axis 105. The inner hub 402 may include an outer surface. The outer surface of the inner hub 402 may join other components on the radial turbine rotor 102. For example, the outer surface of the inner hub 402 may join the inner surface outer ring 404 by a bonding process as described herein. The inner hub 402 may include cooling features that fluidly connect with the outer ring 404. For example, the inner hub 402 may receive cooling fluid from the radial turbine engine and direct the cooling fluid to the outer ring 404.

The outer ring 404 may be structure positioned radially outward from the inner hub 402. In some examples, the outer ring 404 may be positioned between inner hub 402 and the base end 112 of the radial turbine blade 106. For example, the outer ring 404 may include an inner surface and an outer surface. All, or a portion of, the outer surface 108 of the hub 104 may include the outer surface of the outer ring 404. Accordingly, the outer ring 404 may include the discrete bonding surface 110, the saddles 116, 118, the fillet. The inner surface of the outer ring 404 may join with the outer surface of the inner hub 402, as illustrated in the example in FIG. 4. In some examples, the outer ring 404 may join with the inner hub 402 by the bonding process as described herein.

The radial turbine blade 106 may bond to the outer ring 404 to form a first bond 408. For example, bonding the base surface 114 of the radial turbine blade 106 to the discrete bonding surface 110 may form the first bond 408. In addition, the outer ring 404 may bond to the inner hub 402 to form a second bond 410. For example, bonding the inner surface of the outer ring 404 with the outer surface of the inner hub 402 may form the second bond 410.

In some examples, the components of the radial turbine engine may join together by bonding processes that yield bonds of various bond strengths and qualities. For example the first bond 408 and/or the second bond 410 may have bond strength in the range of 30 ksi to 50 ksi. The first bond may have a higher strength than the second bond. Alternativly, or in addition, the first bond 408 may be formed by different bonding process than the second bond 410. For example, the bonding process for the first bond 408 may yield a higher strength bond with less imperfections than the bonding process used for the second bond 410

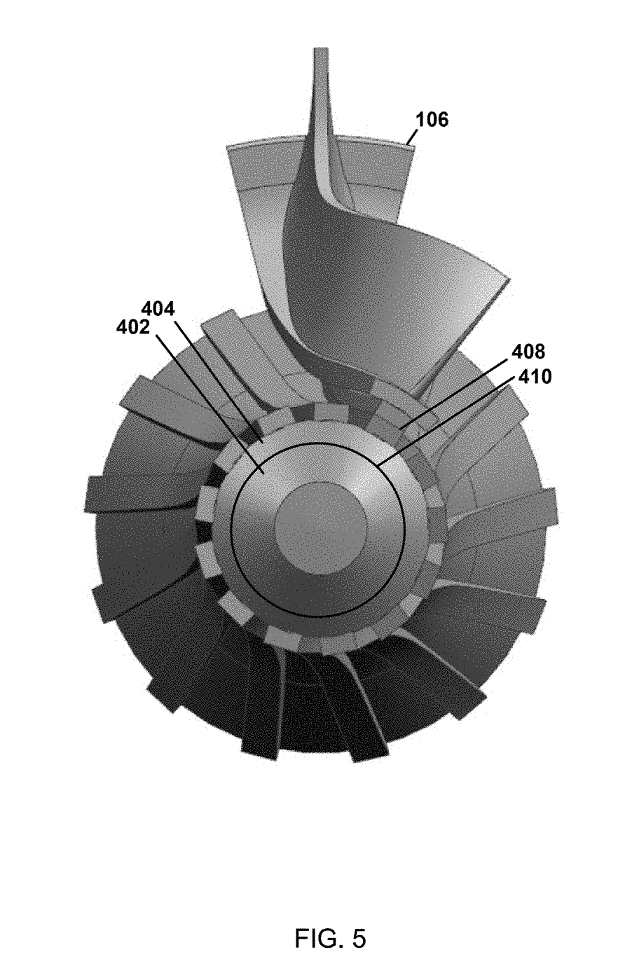

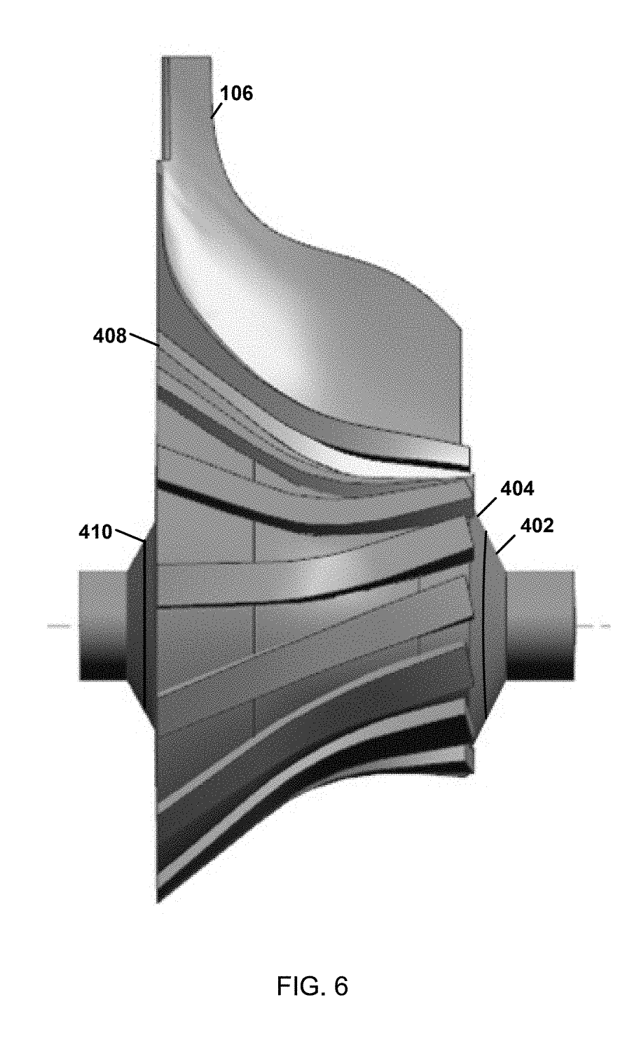

FIG. 5 illustrates a front plan view of an example of the radial turbine rotor 102 including the inner hub 402 and the outer ring 404. FIG. 6 illustrates a side plan view of an example of the radial turbine rotor 102 including the inner hub 402 and the outer ring 404. The outer ring 404 may include the outer surface. The outer surface of the outer ring 404 may include the discrete bonding surface 110. In addition, the radial turbine rotor 102 may include a radial turbine blade 106. The radial turbine blade 106 may include a base end 112 that is bonded to the discrete bonding surface 110. The radial turbine blade 106 may be separate and distinct from other radial turbine blades that are bonded to the radial turbine rotor 102.

In some examples, the radial turbine rotor 102 may include multiple components bonded together to form, create, and/or otherwise construct the radial turbine rotor 102 or any portion thereof. An example of a method to construct the radial turbine rotor 102 may include placing the base end 112 of the radial turbine blade 106 on the outer surface 108 of the hub 104. For example, the method may include aligning the base surface 114 of the radial turbine blade 106 on the discrete bonding surface 110. The method may further include bonding the base end 112 of the radial turbine blade 106 to the discrete bonding surface 110 on the outer surface 108 of the hub 104. The radial turbine blade 106 may be separate and distinct from other radial turbine blades that are bonded on the radial turbine rotor 102. The method may further include bonding the outer surface of the inner hub 402 with the inner surface of the outer ring 404. The outer surface 108 of the hub 104 may include the outer surface of the outer ring 404. The method may further include inspecting the first bond 408 and/or the second bond 410 between the radial turbine blade 106 and the discrete bonding surface 110.

Inspection of the bonds 408, 410 may ensure the adequacy of the first bond 408, the second bond 410, or any other bond on the radial turbine blade 106. The inspection may include various bond inspection techniques, such as sonar inspection. For example, inspection of the first bond 408 may ensure that a stress bond between the radial turbine blade 106 and the outer ring 404 is adequate. In some examples, inspection of the first bond 408 may occur before bonding the outer ring 404 with the inner hub 402. After the first bond 408 is completed, the outer ring 404 may subsequently bond with the inner hub 402. In other examples, bonding and inspection may occur in any order.

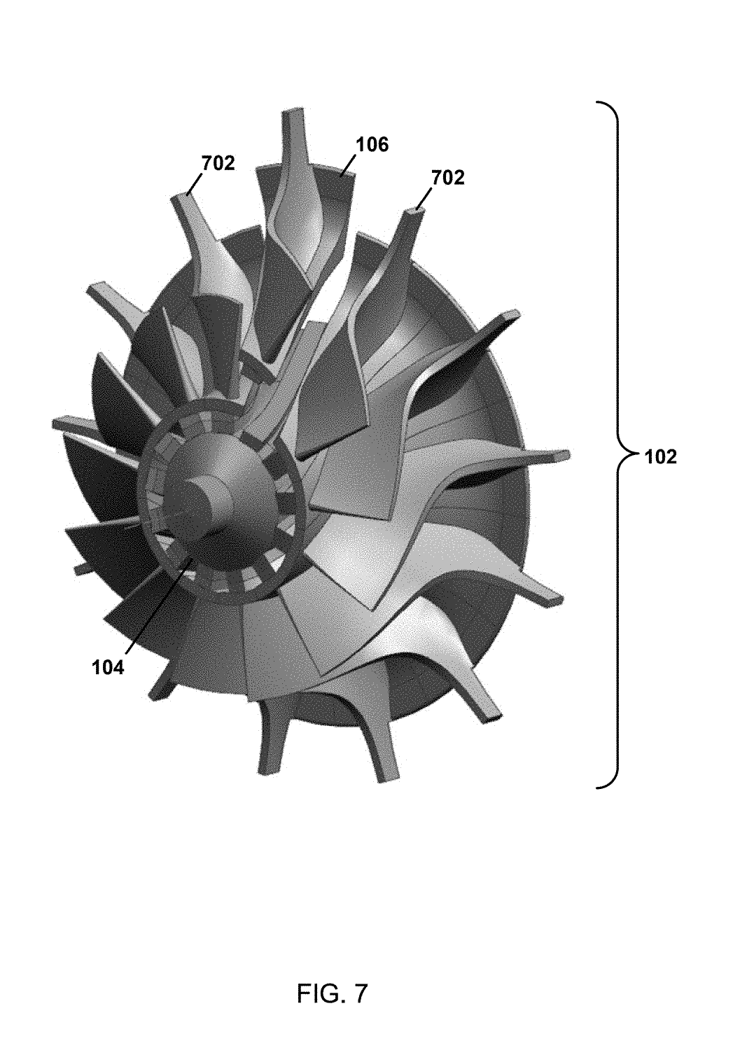

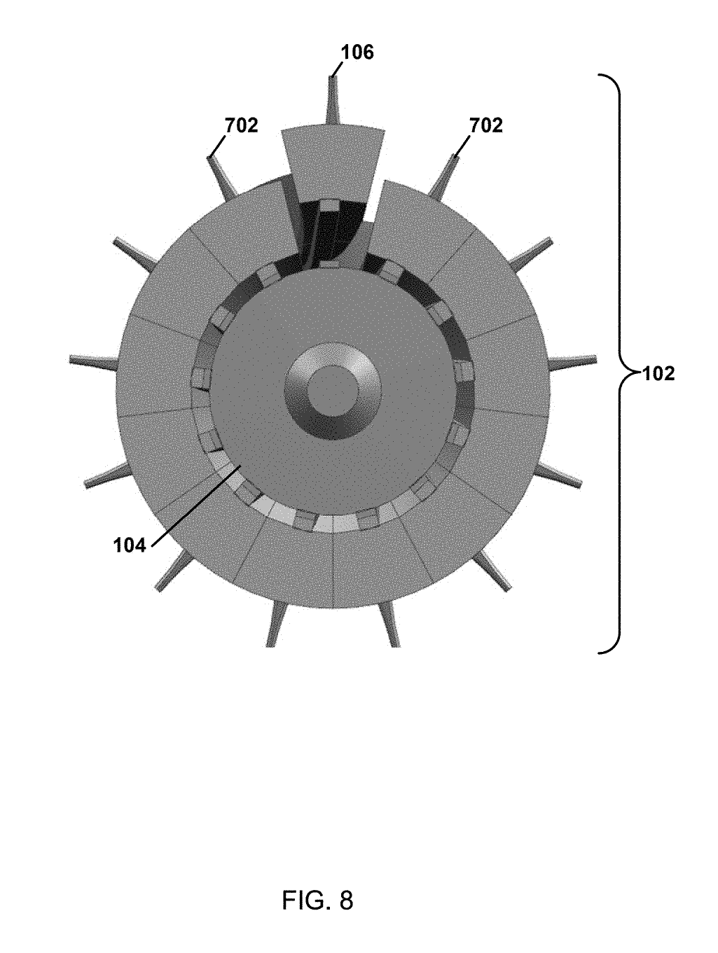

FIG. 7 illustrates a perspective view of an example of the radial turbine blade 106 with adjacent radial turbine blades 702. FIG. 8 illustrates an example of a rear plan view of the radial turbine blade 106 with the adjacent radial turbine blades 702. The adjacent radial turbine blades 702 may bond to the hub 104 adjacent to the radial turbine blade 106. Each of the adjacent radial turbine blades may have the same structure, features, and other attributes as the radial turbine blade 106. Alternatively, one or more of the adjacent radial turbine blades 702 may have additional or alternative structure, features, and/or other attributes to the radial turbine blade 106. The radial turbine blade 106 may be separate and distinct from the adjacent radial turbine blades 702. For example, the radial turbine blade 106 may bond to the hub 104 without bonding to, or otherwise contacting, the adjacent radial turbine blades 702. Further, each of the adjacent radial turbine blades 702 may be separate and distinct. For example, none of the radial turbine blades 106 and 702 may contact or bond to any other of the radial turbine blades 106 and 702.

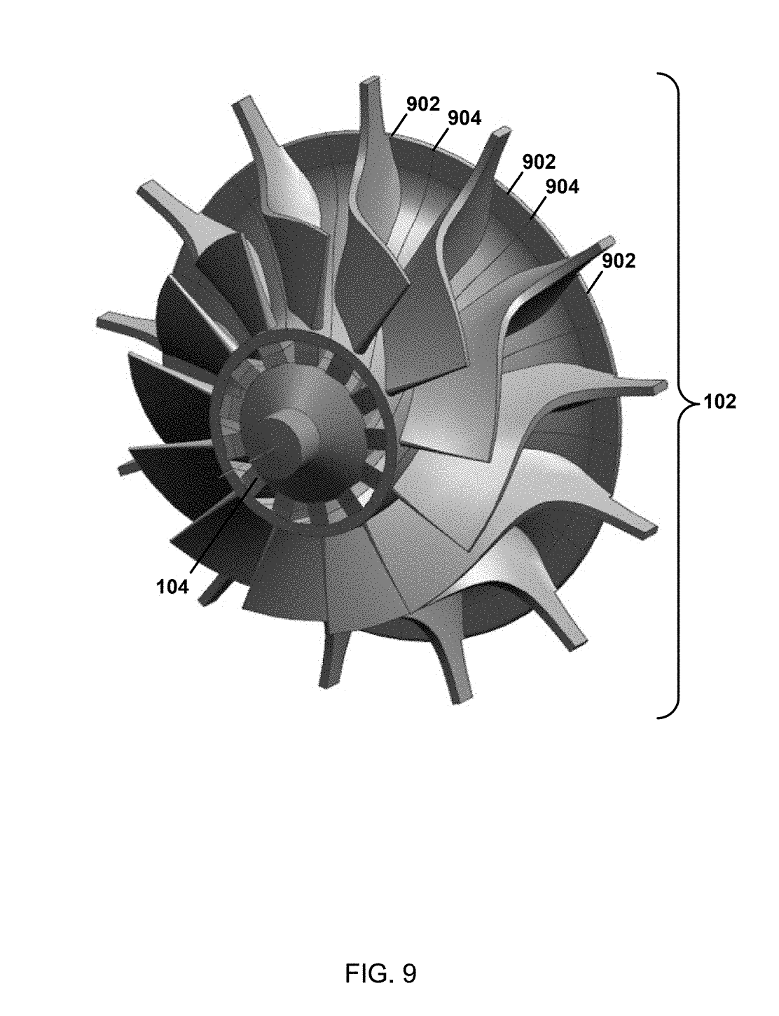

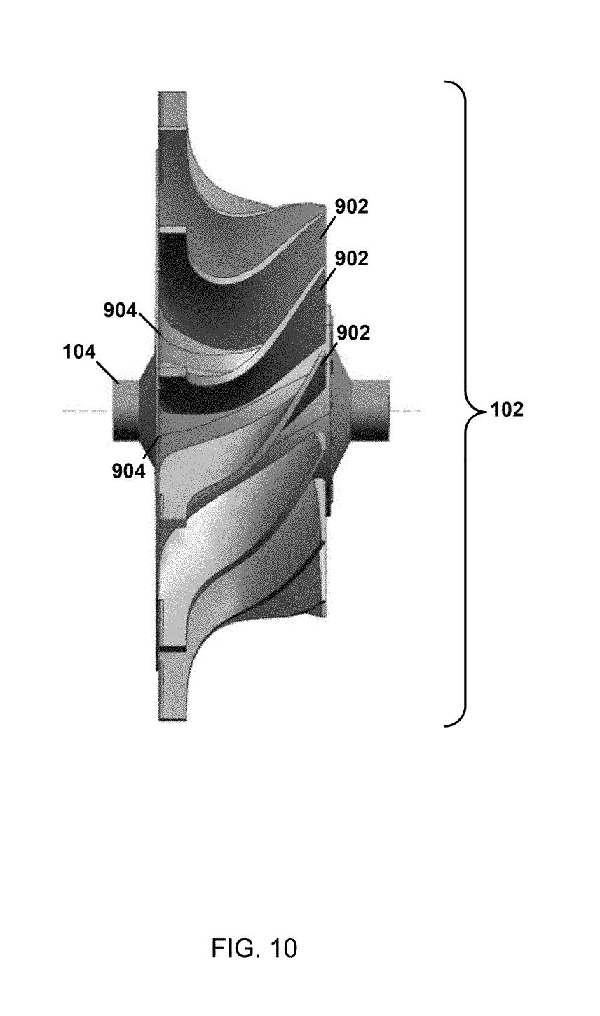

FIG. 9 illustrates a perspective view of an example of the radial turbine rotor 102 with individually bonded blades 902. FIG. 10 illustrates a side view of an example of the radial turbine rotor 102 with the individually bonded blades 902. Each of the individually bonded blades 902 may be an example of the radial turbine blade 106. Thus, each of the individually bonded blades 902 may be separate and distinct each other. For example, the individually bonded blades 902 may define gaps 904 between each of the individually bonded blades 902. The gaps 904 may be voids between each of the individually bonded blades 902. Alternatively, a filler material may fill the gaps 904 between the individually bonded blades 902. The filler material may separate each of the individually bonded blades 902. Alternatively, or in addition, the filler material may ensure that other undesirable material and/or fluid, such as exhaust flow, does not accumulate in the gaps 904. Examples of the filler material may include a sheet of metal lodged in each of the gaps 904. The sheet of metal may be held in place by the individually bonded blades 904. For example, friction between may hold the sheet of metal in the gaps 904 between each of the individually bonded blades 904.

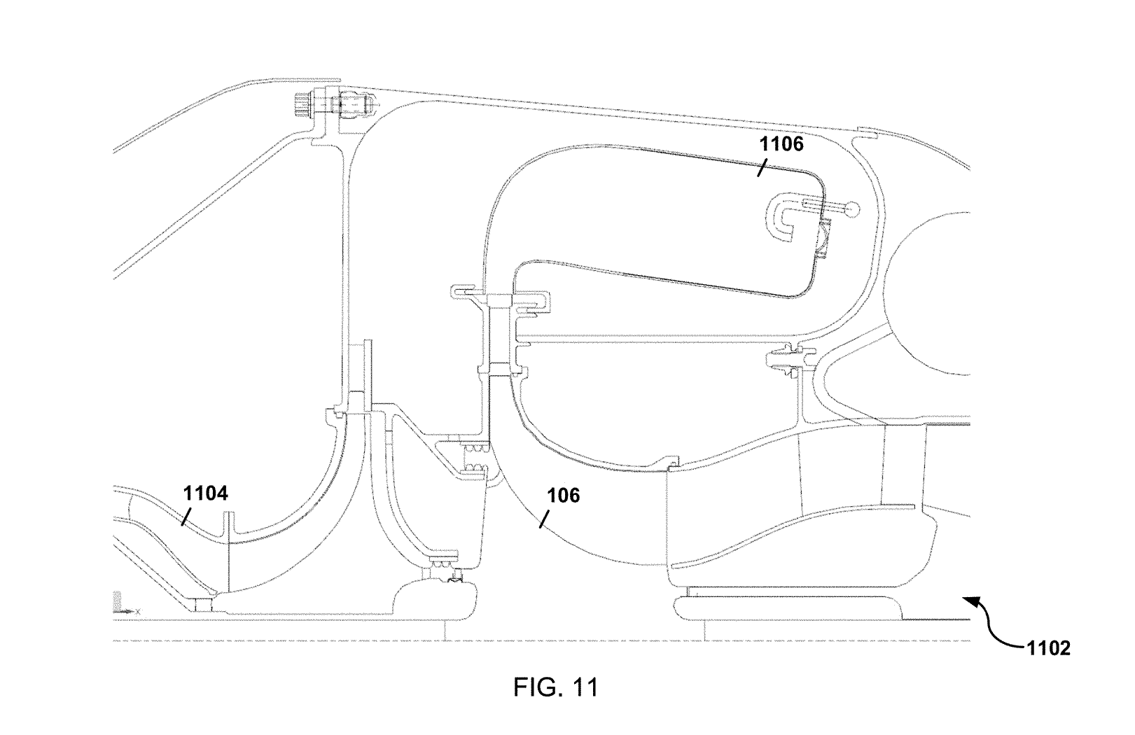

FIG. 11 illustrates an example of a portion of a gas turbine engine 1102 with the radial turbine blade 106. The gas turbine engine 1102 may include a compressor 1104, a combustor 1106, the radial turbine rotor 102 with the radial turbine blade 106 and additional components suitable for a radial turbine engine. The compressor 1104 may compress air flowing in the radial turbine engine 1102. Compressed air may be directed through to the combustor 1106 and mixed with a fuel. The mixture of the compressed air and the fuel may ignite to create exhaust. The exhaust may flow radially to the radial turbine blade 106. The radial turbine blade 106 may receive the exhaust flow to drive the radial turbine rotor 102.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.\

While various embodiments have been described, it will be apparent to those of ordinary skill in the art that many more embodiments and implementations are possible. Accordingly, the embodiments described herein are examples, not the only possible embodiments and implementations.

The subject-matter of the disclosure may also relate, among others, to the following aspects:
1. A radial turbine rotor for a gas turbine engine, the radial turbine rotor comprising:

a hub including an outer surface, the outer surface including a discrete bonding surface; and

a radial turbine blade including a base end that is bonded to the discrete bonding surface of the hub, wherein the radial turbine blade is separate and distinct from other radial turbine blades that are bonded to the radial turbine rotor.
2. The radial turbine rotor of aspect 1, wherein the hub further includes a first saddle and a second saddle, the first saddle and the second saddle located along the outer surface of the hub, wherein the discrete bonding surface is positioned between the first saddle and the second saddle.
3. The radial turbine rotor of any of aspects 1 to 2, wherein the hub further includes a fillet, wherein the fillet is positioned at the outer surface of the hub and along the base end of the radial turbine blade.
4. The radial turbine rotor of any of aspects 1 to 3, wherein the radial turbine blade further comprises at least one of a single crystal material or an equiax material.
5. The radial turbine rotor of any of aspects 1 to 4, wherein the discrete bonding surface is planer.
6. The radial turbine rotor of any of aspects 1 to 5, wherein the base end of the radial turbine blade includes a base surface that is planer, wherein the base surface is bonded to the discrete bonding surface of the hub.
7. The radial turbine rotor of any of aspects 1 to 6, wherein the hub further comprises an outer ring and an inner hub, the outer ring positioned radially outward from the inner hub, wherein an inner surface of the outer ring is bonded to an outer surface of the inner hub, and the outer surface of the hub includes an outer surface of the outer ring.
8. A radial turbine rotor for a gas turbine engine, the radial turbine rotor comprising:

a hub including an outer surface, the outer surface including a plurality of discrete bonding surfaces;

a plurality of radial turbine blades each bonded to a corresponding one of the discrete bonding surfaces of the hub, wherein each of the radial turbine blades is separate and distinct from the other of the radial turbine blades that are bonded to the radial turbine rotor.
9. The radial turbine rotor of aspect 8, wherein each of the radial turbine blades comprises a cooling feature.
10. The radial turbine rotor of any of aspects 8 to 9, wherein the radial turbine blade includes a stalk, wherein the stalk includes a cooling hole.
11. The radial turbine rotor of any of aspects 8 to 10, wherein the radial turbine blades define a gap in between the radial turbine blades, wherein the radial turbine blades are separated by the gap.
12. The radial turbine rotor of any of aspects 8 to 11, wherein each of the radial turbine blades includes an internal passageway.
13. The radial turbine rotor of any of aspects 8 to 12, wherein the hub further includes a plurality of fillets, wherein each of the fillets is positioned along an outer perimeter of the corresponding one of the discrete bonding surfaces.
14. The radial turbine rotor of any of aspects 8 to 13, wherein each of the radial turbine blades is brazed, linear friction welded, or diffusion bonded to the corresponding one of the discrete bonding surfaces.
15. A method, comprising:

bonding, by a bonding process, a base end of a radial turbine blade to a discrete bonding surface on an outer surface a hub of a radial turbine rotor, wherein the radial turbine blade is separate and distinct from other radial turbine blades that are bonded on the radial turbine rotor.
16. The method of aspect 15 further comprising bonding an outer surface of an inner hub to an inner surface of an outer ring, wherein the hub comprises the inner hub and the outer ring, wherein an outer surface of the outer ring includes the discrete bonding surface.
17. The method of any of aspects 15 to 16 further comprising inspecting a bond between the radial turbine blade and the discrete bonding surface.
18. The method of any of aspects 15 to 17 wherein the bonding process comprises at least one of braising, linear friction welding, or diffusion bonding.
19. The method of any of aspects 15 to 18 wherein the radial turbine blade further comprises at least one of a single crystal material or an equiax material.
20. The method of any of aspects 15 to 19, wherein the discrete bonding surface is planer.

What is claimed is:

1. A radial turbine rotor for a gas turbine engine, the radial turbine rotor comprising:
a hub including an outer surface, the outer surface including a discrete bonding surface; and
a radial turbine blade including a base end that is bonded to the discrete bonding surface of the hub, wherein the radial turbine blade is separate and distinct from other radial turbine blades that are bonded to the radial turbine rotor.

2. The radial turbine rotor of claim 1, wherein the hub further includes a first saddle and a second saddle, the first saddle and the second saddle located along the outer surface of the hub, wherein the discrete bonding surface is positioned between the first saddle and the second saddle.

3. The radial turbine rotor of claim 1, wherein the hub further includes a fillet, wherein the fillet is positioned at the outer surface of the hub and along the base end of the radial turbine blade.

4. The radial turbine rotor of claim 1, wherein the radial turbine blade further comprises at least one of a single crystal material or an equiax material.

5. The radial turbine rotor of claim 1, wherein the discrete bonding surface is planer.

6. The radial turbine rotor of claim 1, wherein the base end of the radial turbine blade includes a base surface that is planer, wherein the base surface is bonded to the discrete bonding surface of the hub.

7. The radial turbine rotor of claim 1, wherein the hub further comprises an outer ring and an inner hub, the outer ring positioned radially outward from the inner hub, wherein an inner surface of the outer ring is bonded to an outer surface of the inner hub, and the outer surface of the hub includes an outer surface of the outer ring.

8. A radial turbine rotor for a gas turbine engine, the radial turbine rotor comprising:
a hub including an outer surface, the outer surface including a plurality of discrete bonding surfaces;
a plurality of radial turbine blades each bonded to a corresponding one of the discrete bonding surfaces of the hub, wherein each of the radial turbine blades is separate and distinct from the other of the radial turbine blades that are bonded to the radial turbine rotor.

9. The radial turbine rotor of claim 8, wherein each of the radial turbine blades comprises a cooling feature.

10. The radial turbine rotor of claim 8, wherein the radial turbine blade includes a stalk, wherein the stalk includes a cooling hole.

11. The radial turbine rotor of claim 8, wherein the radial turbine blades are arranged so that a gap is between each of the radial turbine blades.

12. The radial turbine rotor of claim 8, wherein each of the radial turbine blades includes an internal passageway.

13. The radial turbine rotor of claim 8, wherein the hub further includes a plurality of fillets, wherein each of the fillets is positioned along an outer perimeter of the corresponding one of the discrete bonding surfaces.

14. The radial turbine rotor of claim 8, wherein each of the radial turbine blades is brazed, linear friction welded, or diffusion bonded to the corresponding one of the discrete bonding surfaces.

15. A method, comprising:
bonding, by a bonding process, a base end of a radial turbine blade to a discrete bonding surface on an outer surface a hub of a radial turbine rotor, wherein the radial turbine blade is separate and distinct from other radial turbine blades that are bonded on the radial turbine rotor.

16. The method of claim 15 further comprising bonding an outer surface of an inner hub to an inner surface of an outer ring, wherein the hub comprises the inner hub and the outer ring, wherein an outer surface of the outer ring includes the discrete bonding surface.

17. The method of claim 16 further comprising inspecting a bond between the radial turbine blade and the discrete bonding surface.

18. The method of claim 15 wherein the bonding process comprises at least one of braising, linear friction welding, or diffusion bonding.

19. The method of claim 15 wherein the radial turbine blade further comprises at least one of a single crystal material or an equiax material.

20. The method of claim 15, wherein the discrete bonding surface is planer.
